(19) United States
(12) Patent Application Publication
(10) Pub. No.: US 2018/0276776 A1
(43) Pub. Date: Sep. 27, 2018

(54) Process and system in which a person can attend an event like a funeral remotely.

(71) Applicant: Todd Morrow, Guntersville, AZ (US)

(72) Inventor: Todd Morrow, Guntersville, AZ (US)

(21) Appl. No.: 15/467,863

(22) Filed: Mar. 23, 2017

(51) Int. Cl. G06Q 50/18; G06Q 50/00; G06F 17/30; G06Q 30/06; H04L 29/06

(52) U.S. Cl. CPC G06Q 50/186; G06Q 50/01; H04L 65/60; G06Q 30/0633; G06F 17/30864

(57) ABSTRACT

The current invention is system and application that can provide live streaming of an event like funeral services to unite loved ones separated by distance. The system, in the preferred embodiment, can work like a smartphone application or a website application. Users can pay their respects and be part of the service from their cell phone or tablets. The system allows users to filter for local funeral homes, find the service information they need and pass on their respects and condolences. If they can't attend for any reason, they can watch the service through the system's live streaming network, which is password protected and secure. The system will further provides a one-stop platform for friends and relatives to donate money or flowers for the event.

### CROSS-REFERENCES TO RELATED APPLICATIONS (IF ANY)

None

### BACKGROUND

### 1. Field of the Invention

The present invention relates to a process for attending an event like a funeral in particularly attending remotely.

### 2. Description of Prior Art

A family bereavement is a difficult time. When people lose someone close to them, the last thing anyone wants is to contemplate making funeral arrangements. For relatives and friends separated by distance, finding the money to return for the service sometimes isn't a possibility.

There is still room for improvement in the art.

### SUMMARY OF THE INVENTION

The current invention is system and application that can provide live streaming of a event like funeral services to unite loved ones separated by distance.

The system, in the preferred embodiment, can work like a smartphone application or a website application.

Mourners can pay their respects and be part of the service from the system's Funeral Vision application on their cell phone or tablet.

Funeral Vision system allows mourners to filter for local funeral homes, find the service information they need and pass on their respects and condolences. If they can't attend for any reason, they can watch the service through the system's live streaming network, which is password protected and secure. The system will further provides a one-stop platform for friends and relatives to donate money or flowers for the service.

Family members can keep all the details of the proceedings organized, without having to worry if they remembered to order the flowers, or inform the guests. From the date and time of the service, to donation preferences, Funeral Vision relieves some of the stress of your loss.

For those who are unable to attend the service, Funeral Vision's online streaming allows invited attendees to view the service. They can feel as if they are a part of the event, even when separated by distance. They an leave their condolences or donations afterwards from within the Funeral Vision app.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 displays the system's home screen;

FIG. 3 shows the systems information screen;

FIG. 4 shows a screen shot of the filter by name function;

FIG. 5 shows the information screen; and

FIG. 6 shows the funeral being display via a remote connection.

### DESCRIPTION OF THE PREFERRED EMBODIMENT

There are a number of significant design features and improvements incorporated within the invention.

The current invention is a system and application 1 that can provide live streaming of an event like funeral services to unite loved ones separated by distance.

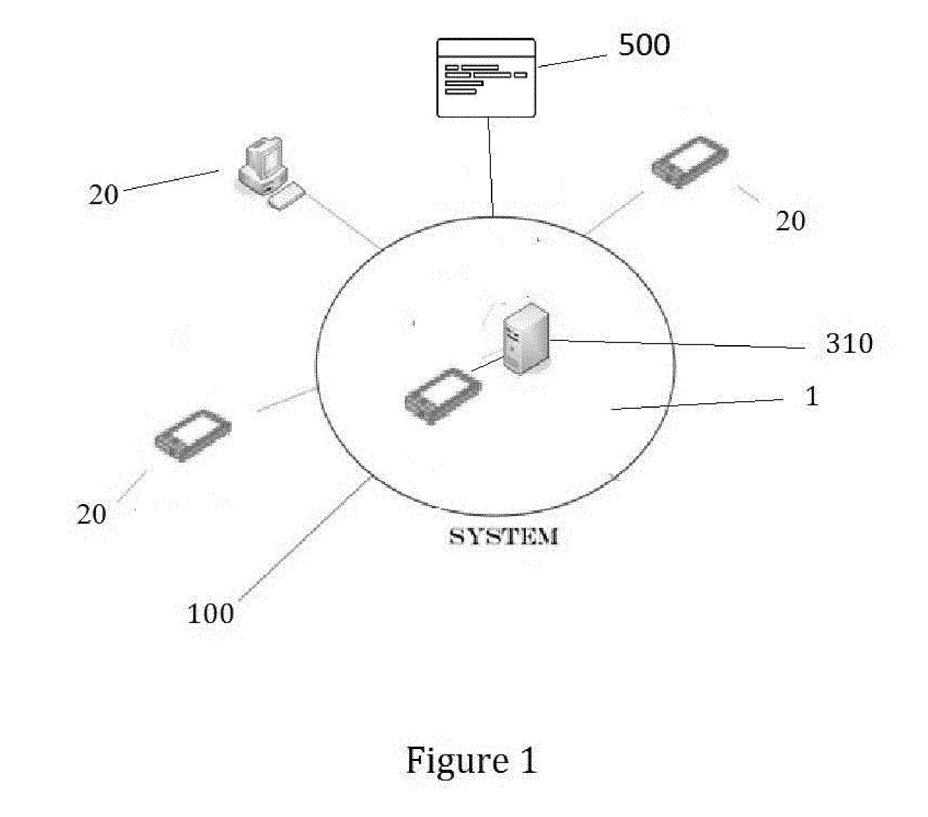

FIG. 1 displays the preferred embodiment of the system architecture 1 accessed through an Internet, Intranet and/or Wireless network 100. However, the system could be implemented on a device-to-device or client/server architecture as well. The system 1 is set to run on a computing device 20 or a website 500.

In FIG. 1, the system 1 is accessed from a user's computing device 10 through a web browser over HTTP and/or HTTPS protocols to a web site 500 or wireless network or cell phone to cell phone connection. A computing device 20, such as a cell phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet or a wireless network. Computing devices 20 like this are well known in the art and are not pertinent to the invention.

The system 1, data and processing code can reside in the non-transitory memory 310 of the one or more computing devices 20. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app) and would have a touch screen 100 to allow a user to swipe the screen when making choices and decisions.

This current invention is a system 1 and app that can provide live streaming 100 of funeral services to unite loved ones separated by distance. This patent will include each user features separate from the other or combined.

The system 1, in the preferred embodiment, can work like a smartphone application or a website application.

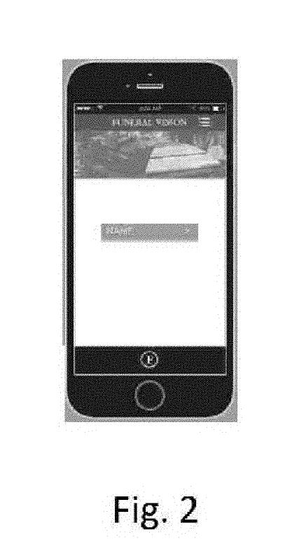

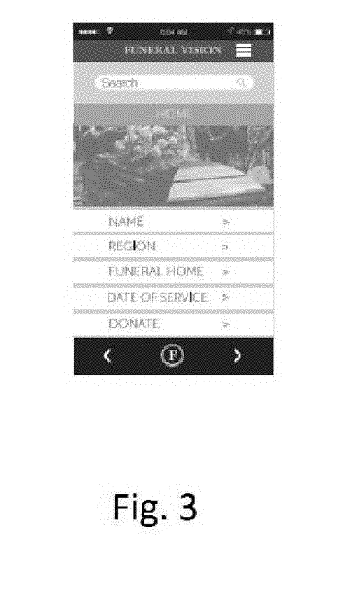

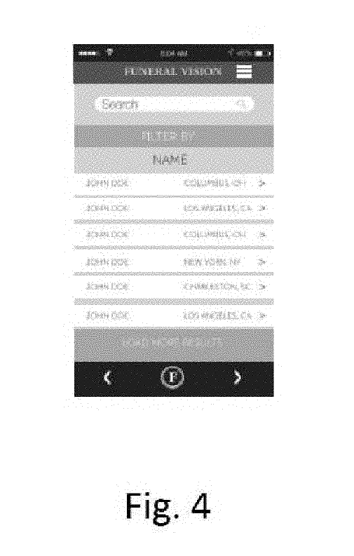

For a funeral, mourners can pay their respects and be part of the service from the system's Funeral Vision application 1 on their computing device 20 like a cell phone or tablet. A sample home page of the application is shown in FIG. 2. The page will show the name of the decease. The system 1 will have an options pages as shown in FIG. 3 where the user can select the funeral by name. region, funeral home and/or date of service. The system 1 will have a search function based on these inputs. FIG. 4 shows a search on name.

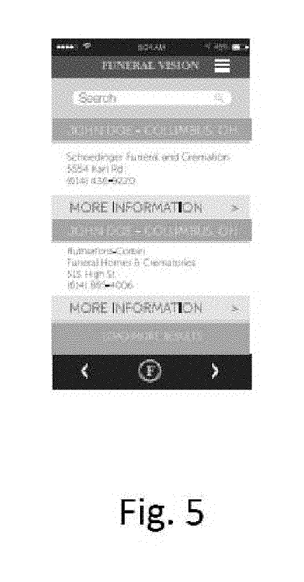

The system 1 allows mourners to filter for local funeral homes, find the service information they need and pass on their respects and condolences. This can be done using the system's information screen as shown in FIG. 5. The user can send donations or send flower as well as sending respects and condolences. If they can't attend for any reason, they can watch the service through the system's live streaming network, which is password protected and secure. The system will further provides a one-stop platform for friends and relatives to purchase items for the event such as donate money or flowers for the service.

Family members can keep all the details of the proceedings organized, without having to worry if they remembered to order the flowers, or inform the guests as the system 1 will provide this. From the date and time of the service, to donation preferences, the system 1 will relieve some of the stress of loss. The system 1 will let the person setting up the information about the funeral to add information such as name, funeral home name and address, the hours of the service and specific donations or flowers requested.

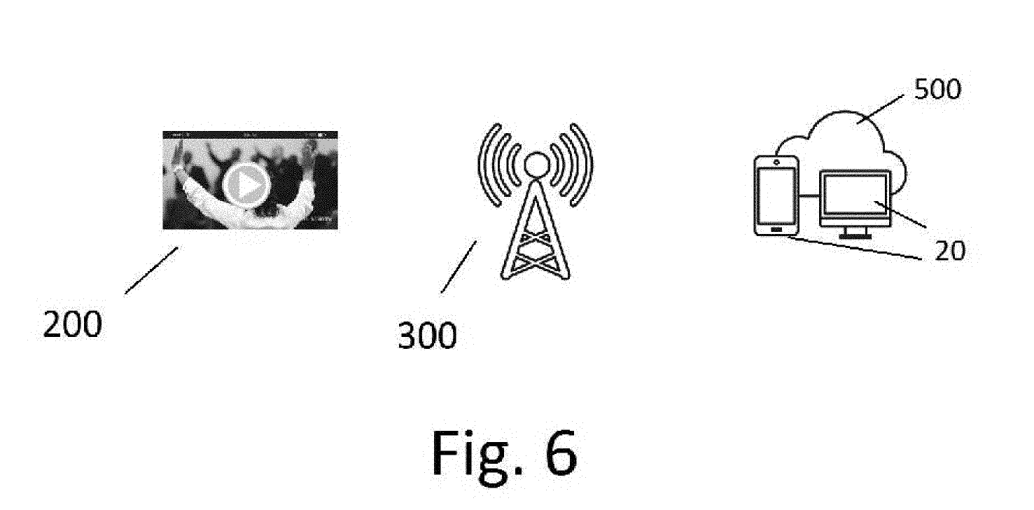

For those who are unable to attend the service, the system's online streaming allows invited attendees to view the service. They can feel as if they are a part of the event, even when separated by distance. This is shown in FIG. 6. The service 200 is recorded and transmitted 300 to the computing devices 20 through the Internet 100 which can also be considered or called the cloud.

The system 1 will have a user who want to use the system 1 for funeral notification will enter all the required data such as name, location, date and time, into the database 310 including who to notify and the system will send out the notices. The system 1 will send out notices either by mail or by electronic means such as E-mail or SMS. The system 1 will also be set up to notify local newspapers with an announcement.

The system 1 can also be used for other life changing events such as weddings or birth announcements with the wedding being streamed through the application 1. With these events, messages may be sent through the system 1 as well as gifts being purchased through the system.

### Advantages

The system 1 enables those who are unable to attend the service to view the service. They can feel as if they are a part of the event, even when separated by distance. Leaving their condolences, gifts or donations afterwards from within the application.

### CONCLUSION

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
placing information about an event into the system;
allowing a search to be done for the event; and
streaming a video of the event.

2. A system according to claim 1 where the event is a funeral.

3. A system according to claim 1 where the event is a wedding.

4. A system according to claim 1 where the event is a birth.

5. A system according to claim 1 where the information is one or more of a set of name, location, date and time.

6. A system according to claim 1 further comprising where a message can be left on the system.

7. A system according to claim 6 where the message is a condolence.

8. A system according to claim 1 where a donation can be left through the system.

9. A system according to claim 1 where a purchase can be made for the event.

10. A system according to claim 1 where computing devices can be used to view the event.

11. A system according to claim 10 where the computing devices connect to event through the Internet.

12. A system according to claim 1 where the system has a search function.

13. A system according to claim 12 where the search function is located on a single screen.

14. A system according to claim 1 where the system is a smart phone application.

15. A system according to claim 1 where the system is run on a website.

16. A system comprising;
having a system that resides in the non-transitory memory of a computing device;
placing information about a funeral into the system;
allowing a search to be done for the event;
sending out information about the funeral;
having a search function;
having said information include name. location, date and time of the funeral;
allowing condolences to be sent by the system; and
streaming a video of the event.

17. A system according to claim 1 where a donation can be left through the system.

18. A system according to claim 1 where a purchase can be made for the funeral.

19. A system according to claim 1 where computing devices can be used to view the funeral.
